(19) United States
(12) Patent Application Publication
(10) Pub. No.: US 2024/0037539 A1
(43) Pub. Date: Feb. 1, 2024

(54) METHODS AND A SYSTEM FOR MANAGING AND INTEGRATING NON-FUNGIBLE TOKENS (NFTS)

(71) Applicant: NCR Corporation, Atlanta, GA (US)

(72) Inventors: Bryan Walser Nonni, Atlanta, GA (US); Alexander Simon Lewin, Atlanta, GA (US); Brent Vance Zucker, Roswell, GA (US)

(21) Appl. No.: 17/876,823

(22) Filed: Jul. 29, 2022

(51) Int. Cl. G06Q 20/36; H04L 9/32; H04L 9/00

(52) U.S. Cl. CPC G06Q 20/3672; H04L 9/3213; H04L 9/50; H04L 2209/56; G06Q 2220/00

(57) ABSTRACT

A cloud-based service is provided that receives conditions for obtaining an object of value from an enterprise. A blockchain-based media of value is created on a blockchain for the object of value. A smart contract is generated an initiated on the blockchain to enforce the conditions with control over the blockchain-based media of value. When a customer provides actions or information that satisfies the conditions to the smart contract the smart contract returns the blockchain-based media of value to a customer wallet. The customer exchanges the blockchain-based media of value for the object of value from the enterprise. In an embodiment, the blockchain-based media of value is a non-fungible token (NFT).

### BACKGROUND

The world of non-fungible tokens (NFTs) has exploded in popularity, use, and value. According to Statistica.com®, the amount of sales of NFTs via Ethereum (ETH) blockchain jumped from $250,000 to $6.5 million from December 2020 to January 2021 leading to a record high of $82 million in August 2021. Given their recent mainstream popularity, the market is positioned in such a way for large-scale companies to take advantage of the trend.

NFTs are difficult to create and manage because the technology is so new and is thus less understood. The common corporation is typically neither technically savvy enough nor efficient enough with time, resource, or money to pivot and leverage cutting edge technology like NFTs, ETH, etc. Yet, companies can and should benefit from the innovation associated with NFTs. Few option are available to large corporations to provide this technology to their customers.

Existing options include investing in an innovation lab project internal to the corporation, which is costly. Alternative, corporations can contract or partner with smaller technology companies for services, which is also costly and can be very inefficient.

NFTs are not going away and can be used for a variety of purposes, such as proof of ownership, used to purchase one-of-a-kind items, used to create and own digital art, etc. NFTs can only have one owner at a time and a secured by the ETH blockchain, such that no one can modify the record of ownership or even copy and paste a new NFT into existence.

### SUMMARY

In various embodiments, methods and a system for managing and integrating NFTs are presented. An interface is provided to enterprises for defining conditions and rules associated with their loyalty systems and/or promotion systems. The enterprise provides an object of value obtainable when the conditions and rules are satisfied by a customer of the enterprise. A blockchain-based media of value is created on the blockchain for the object of value. A smart contract is generated as instructions that enforce the rules and conditions and have access to the blockchain-based media of value. When a customer satisfies the conditions and rules, the smart contract transfers the blockchain-based media of value to wallet of the customer. The customer exchanges the blockchain-based media of value with the enterprise to obtain the object of value.

According to an aspect, a method of managing and integrating NFTs is presented. Conditions are received for obtaining an object of value and a blockchain-based media of value for the object of value is created on a blockchain. Instructions for the conditions are generated in a smart contract and an identifier for referencing the smart contract over the blockchain is established. Control over the blockchain-based media of value is provided to the instructions of the smart contract, the smart contract is instantiated over the blockchain, and the identifier is provided for interacting with the instructions of the smart contract on the blockchain.

### BRIEF DESCRIPTION OF THE DRAWINGS

FIG. 1A is a diagram of an example workflow for managing and integrating NFTs, according to an example embodiment.

FIG. 1B is a diagram of a system for processing example workflow of FIG. 1A and other workflows that manage and integrate NFTs, according to an example embodiment.

FIG. 2A is a diagram of a method of managing and integrating NFTs, according to an example embodiment.

FIG. 2B is a diagram of embodiments of the method of FIG. 2A.

FIG. 2C is a diagram of additional embodiments of the method of FIG. 2A.

FIG. 3A is a diagram of another method of managing and integrating NFTs, according to an example embodiment.

FIG. 3B is a diagram of embodiments of the method of FIG. 3A.

### DETAILED DESCRIPTION

Non-fungible tokens (NFTs) are not exclusive linked to digital art and proof of ownership. In fact, NFTs provide a blockchain-based mechanism by which parties can create, buy, sell, trade, and track unique experiences and unique objects. Some of the objects may be associated with real-world objects and others may be associated with digitally created objects. Enterprises lack the ability to take advantage of this technology in ways that benefit the enterprises, such as through loyalty programs, gamification related to sales of the enterprises, promotions, etc. The techniques presented herein and below provide a means by which enterprises are provided interfaces for creating NFTs related to their loyalty and promotion systems with a cloud-based NFT integration and management service. Application Programming Interfaces (APIs) are used to interact with the interfaces and instantiate the smart contract on a blockchain. The enterprises' customer-provided mobile applications are enhanced to provide the rules for satisfying the smart contact to obtain something of value from the smart contract being offered by the enterprises to their customers. The customers use the enhanced mobile applications to interact with the NFT integration and management service and provide what is necessary to obtain the object of value from the smart contract. What is provided by the customers are relayed over the blockchain to the smart contracts on behalf of the customers and the object value is returned and held in custodial wallets by the NFT integration and management service on behalf of the customers. The mobile applications in combination with the custodial wallets can be used to present the object of value directly from the customers to the enterprises. The enterprises then redeem or record the object of value on behalf of their customers. Various other scenarios are possible and described herein and below.

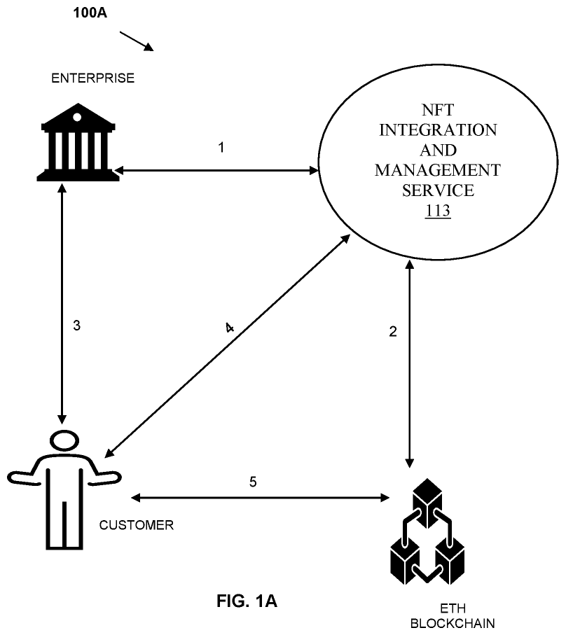

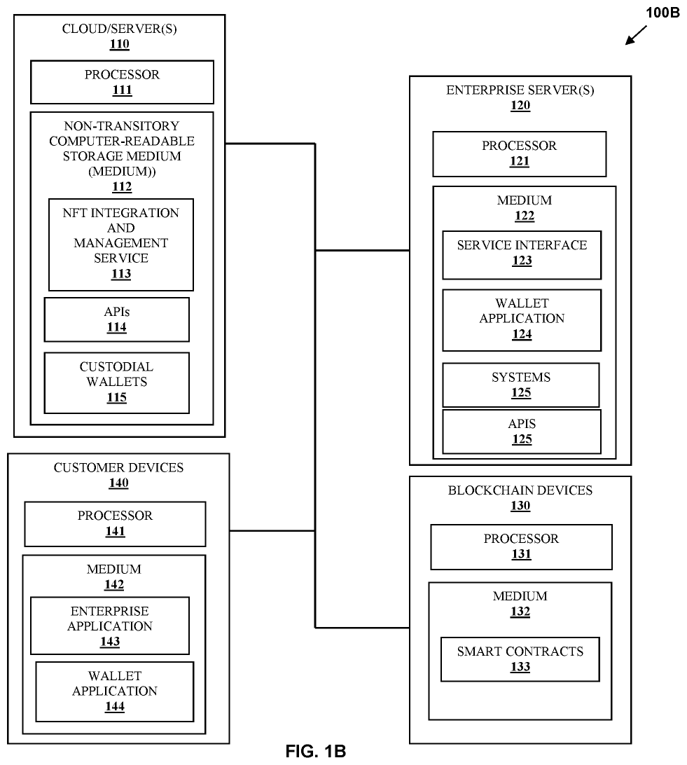

FIG. 1A depicts an example workflow 100A for managing and integrating NFTs, according to an example embodiment. Initially, at 1, an enterprises decides on a service that it wants to offer to its customers through its enhanced mobile application. Accessing an interface, at 1, the enterprise defines conditions for a smart contract and provides an object of value that is to be automatically provided by the instructions of the smart contract with a given customer or set of customers satisfies the conditions of the smart contract. The object of value may already exist and in such case can be transferred from a wallet associated with the enterprise. Alternative, the object of value can be defined through the interface. The NFT integration and management service 113 receives, at 1, the conditions for the smart contract and the object of value or a definition of the object of value from the enterprise. The NFT integration and management service 113 uses the API to create an NFT for the object of value over a blockchain.

At 2, the NFT integration and management service 113 uses a blockchain API 114 to create and fund the smart contract using the conditions and the NFT. The instructions for the smart contract are then initiated over a blockchain. At 1, the NFT integration and management service 113 notifies the enterprise that the smart contract is operational on the blockchain. At 3, the enterprises pushes rules to its enhanced mobile application that instructs the customer on how the NFT for the object of value can be obtained from the smart contract. The customer performs some action or acquires some token or other information required by the conditions, which are recorded in the enhanced mobile application. At 4, the enhanced mobile application reports the action, token, or other information to the NFT integration and management service 113. If a custodial wallet for the customer was not already established, the NFT integration and management service 113 creates a custodial wallet on behalf of the customer. At 4, the NFT integration and management service 113 sends a wallet identifier or address for the custodial wallet of the customer and an action identifier for the action, the token, or the other information to the smart contract over the blockchain. The instructions of the smart contract determine that the conditions were satisfied based on the provided action identifier, the token, or the other information and transfers the NFT for the object of value back to the customer's custodial wallet.

At 4, the NFT integration and management service 113 presents within the enhanced mobile application the custodial wallet with the NFT for the object of value to the customer. At 3, the customer operating the enhanced mobile application presents the NFT to the enterprise. Also, at 3, the enterprise returns or credits an account associated with the customer with the object of value.

The above-referenced example is one of many that are foreseeable with the teachings presented here. Thus, the example workflow is not considered to be limiting to other embodiments presented herein and below.

As used herein, the phrase “object of value” is intended to mean something that is redeemable by a customer with an enterprise. For example, an object of value may be a coupon, loyalty reward points, merchandise, travel awards, game artifacts for a game being offered by the enterprise, cash back, digital art, entertainment award, a unique experience offered to the customer, etc.

As used herein, the phrase “blockchain-based media of value” is intended to mean cryptocurrency, NFTs, or any other blockchain address associated with something of value between parties. Thus, any blockchain-based media of value can be cryptocurrency, NFTs, or any other block-chain based token or data structure regarded as having value by parties.

FIG. 1B is a diagram of a system 100B for managing and integrating NFTs, according to an example embodiment. FIG. 1B also implements the example workflow discussed in FIG. 1A and other workflows as discussed herein and below. It is to be noted that the components are shown schematically in greatly simplified form, with only those components relevant to understanding of the embodiments being illustrated.

Furthermore, the various components (that are identified in the FIG. 1B) are illustrated and the arrangement of the components is presented for purposes of illustration only. It is to be noted that other arrangements with more or fewer components are possible without departing from the teachings of managing and integrating NFTs, presented herein and below.

System 100B includes at least one cloud/server 110, one or more enterprise servers 120, blockchain devices 130, and customer-operated devices 140. Cloud/server 110 includes a processor and a non-transitory computer-readable storage medium 112. Medium 112 includes executable instructions for a NFT integration and management service 113, APIs 114, and custodial wallets 115, which when executed by processor 111 in turn causes processor 111 to perform operations discussed herein and below with respect to 113-115.

Each enterprise server 120 includes a processor 121, a non-transitory computer-readable storage medium 122. Medium 122 includes executable instructions for a service interface 123, a wallet application (app) 124, systems 125 (for example, a loyalty system 125, a promotion system 125, etc.), and APIs 126, which when executed by processor 121 causes processor 121 in turn to perform operations discussed herein and below for 123-126.

Blockchain devices include processors 131 and a non-transitory computer-readable storage mediums 132. Mediums 132 includes executable instructions for smart contracts 133, which when executed by the processors 131 cause processors 131 in turn to perform operations discussed herein and below for smart contracts 133.

Customer device 140 includes a processor 141 and a non-transitory computer-readable storage medium 142. Medium 142 includes executable instructions for an enterprise application 143 and a wallet application 144, which when executed by processor 141 in turn causes processor 141 to perform operations discussed herein and below with respect to 143-144.

Initially, an existing enterprise application for a given enterprise is enhanced as enterprise application 143. The enhancements permits enterprises to push promotions, games, loyalty, etc. offerings directly to enterprise application 143. Enterprise application 143 also includes a cryptocurrency wallet application 144 for a given customer. Enterprise application 143 is further enhanced with a workflow and/or API to interact with NFT integration and management service 113 (hereinafter just service 113).

Cloud 110 or Server 100 (hereinafter just cloud 110) maintains custodial cryptocurrency wallets on behalf of each enterprise and each customer of the enterprise. A ledger is maintained with the custodial wallets 115 that balances and keeps track of what is funded in each wallet application 144 of each customer and funded in each wallet application 124 of each enterprise.

An agent of an enterprise operates service interface 123 to define an object of value or provide the object of value along with conditions for which the object of value can be obtained by a customer of the enterprise. The object of value or a definition of the object of value and the conditions are provided through interface 123 to service 113.

Service 113 uses the object of value or definition of the object of value to create a blockchain-based media of value (such as an NFT) using the APIs 114 and blockchain devices 130. Service 113 then generates instructions for conditions and generates an instance of a smart contract that enforce the conditions over the blockchain devices 130. Optionally, service 113 generates a wallet for the smart contract and embeds the wallet identifier for the wallet within the instructions of the smart contract. In another case, a wallet identifier for the custodial wallet 115 of the enterprise is embedded in the instructions. The newly created blockchain-based media of value is transferred to the smart contract's wallet or the custodial wallet 115 of the enterprise. An address or identifier for the smart contract is generated and the instructions for the smart contract are initiated over the blockchain devices 130 as an instance of smart contract 133. The address or identifier for reaching the instructions of the smart contract are provided back to the service interface 123 and the agent is informed that an NFT for the object of value was created, and the smart contract initiated over the blockchain.

APIs 125 are processed to communicate the object of value or the blockchain-based media of value, the identifier for the smart contract 133, and the conditions for obtaining the object of value to the enterprise application 143 of the customer. The customer then performs an action or provides information through enterprise application 143 associated with the identifier of the smart contract 133. For example, a customer may scan a Quick Response (QR) code within a user facing interface of enterprise application 143 using an integrated camera of customer device 140. Enterprise application 143 decodes the QR code and provides the decoded information with the smart contract identifier to service 113 on behalf of the customer. Service 113 identifies a device identifier for device 140 as being registered to the customer, obtains a custodial wallet identifier for the customer from the custodial wallets 115 and sends the decoded information with the customer's custodial wallet identifier to the smart contract 133 using APIs 114.

The smart contract 133 evaluates the information in view of its instructions and if the conditions associated with the instructions are satisfied from the decoded information from the QR code, the smart contract 133 processes instructions to transfer the blockchain-based media of value associated with the object of value to the customer's custodial wallet using the provided customer custodial wallet identifier. Service 113 interacts with the customer's wallet application 144 to show that the customer is now in possession of the blockchain-based media of value.

The customer uses enterprise application 143 to present the blockchain-based media of value to the APIs 125 of the enterprise. This kicks off a workflow of the enterprise to transfer the object of value associated with the blockchain-based media of value to the enterprise application 143 of the customer and/or credit an account associated with the customer with the object of value. The workflow may or may not also transfer the blockchain-based media of value from the wallet of the customer to a wallet of the enterprise in exchange for the enterprise providing the object of value to the customer.

System 1008 may take subscription-based fees or transactional fees from the enterprises, the customers, or both the customers and the enterprises. In some cases, no fees are taken and service 113 is provided as a value-added service free to the enterprises and customers of the enterprises.

System 100B permits enterprises to integrate and manage blockchain-based media of value through service 113 without the enterprises nor their customers requiring access to blockchain devices 130 associated with a blockchain and without requiring software for accessing the blockchain. Enterprises can leverage contests, games, promotions, and loyalty activity by offering an object of value for which customers can claim should they perform some activity or acquire some information. The conditions for obtaining the object of value are embedded within a smart contract 133 by service 113 on behalf of the enterprise. A unique blockchain-based media of value is created for the object of value over the blockchain and stored in a wallet associated with or accessible to the instructions of the smart contract 133. The enterprise application 143 provides the action or information when obtained by a customer and automatically provides to service 113. Service 113 provides a wallet identifier for the customer and an action identifier for the action or the information to the smart contract 133 using APIs 114. The smart contract 133 automatically transfers the NFT to the wallet of the customer when the action identifier or the information satisfies the conditions set by the enterprise. The customer can then use enterprise application 143 to exchange the NFT for the object of value.

A variety of applications are possible. For example, enterprise application 143 may record purchases of a customer along with the store's location. The enterprise may set up a game that awards an exclusive in-person experience to an individual having visited and purchased something from each of its stores or having the most visited stores within a configured period of time. When enterprise application 143 confirms a customer meets the conditions set, service 113 is contacted with the details and the smart contract identifier for the smart contract 133. The blockchain-based media of value is transferred to the customer's wallet from the smart contract 133. The enterprise application 143 interacts with APIs 125 to kick off a workflow that transfers the blockchain-based media of value to the enterprise's wallet and credits an account of the consumer with a voucher for the exclusive in-person experience.

In another example, product containers include codes associated with a game of the enterprise. The codes are used to obtain the blockchain-based media of value from the corresponding smart contracts 113 and the customer's game play is updated with the artifact associated with the blockchain-based media of value.

In still another example, purchases with the enterprise totaling over a threshold amount within a configured period of time triggers enterprise application 143 to engage service 113 and the corresponding smart contract 133 to return blockchain-based media of value. The customer redeems for a unique digital artwork, a promotion, cash back, a coupon, an exclusive in-person experience, merchandise, etc.

In an embodiment, enterprise application 143 is provided, distributed, and managed by cloud 110 and interacts with APIs 125 of corresponding enterprise servers 120 based on the smart contract identifier. In this embodiment, the application 143 can support multiple different enterprises and multiple different systems 125 offering an object of value to a customer.

In an embodiment devices 140 may include phones, tablets, laptops, and wearable processing devices. In an embodiment, at least one device 140 is an Internet-of-Things (IoT) device.

In an embodiment, the blockchain-based media of value is an NFT. In an embodiment, the blockchain established over the blockchain devices 130 is an Ethereum blockchain.

System 100B allows an enterprise to integrate its loyalty system 125, customer relationship management (CRM) system 125, and/or promotion system 125 with blockchain-based media of value to entice its customers and establish customer loyalty. The enterprise customers will become more engaged and actively participate through the enterprise's customer mobile applications 143.

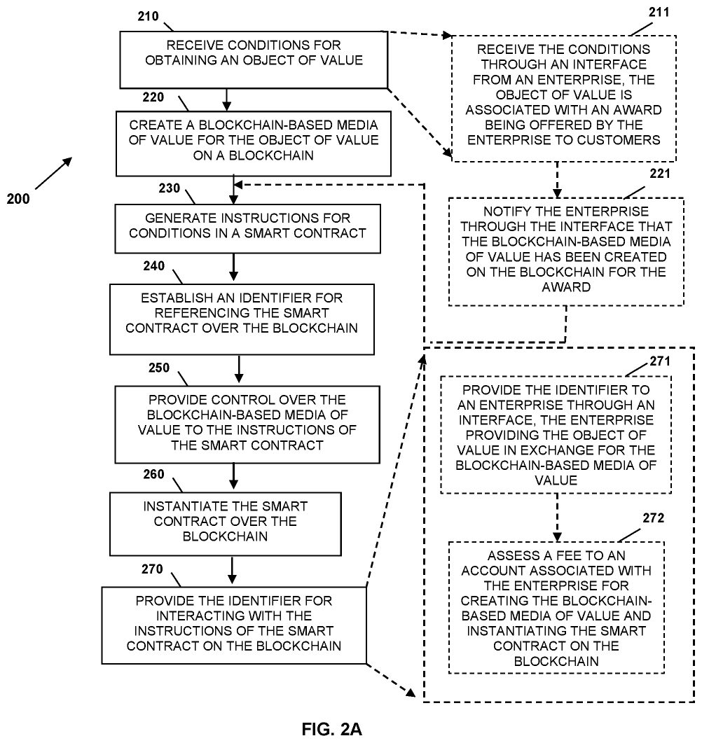

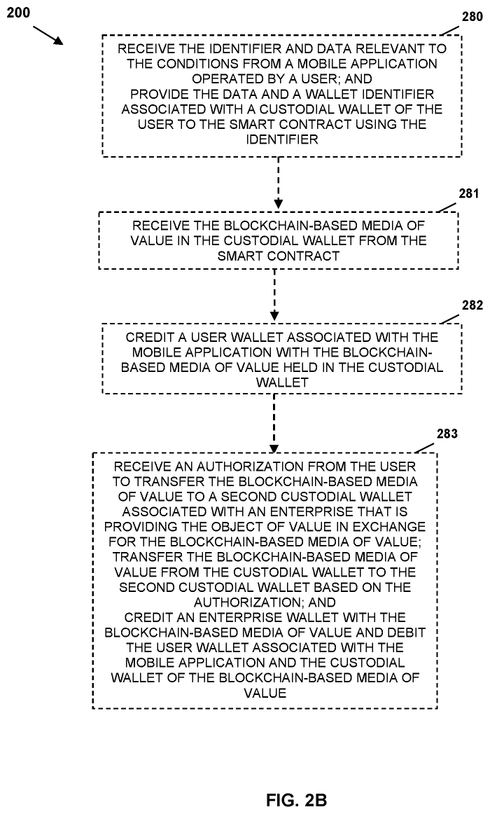

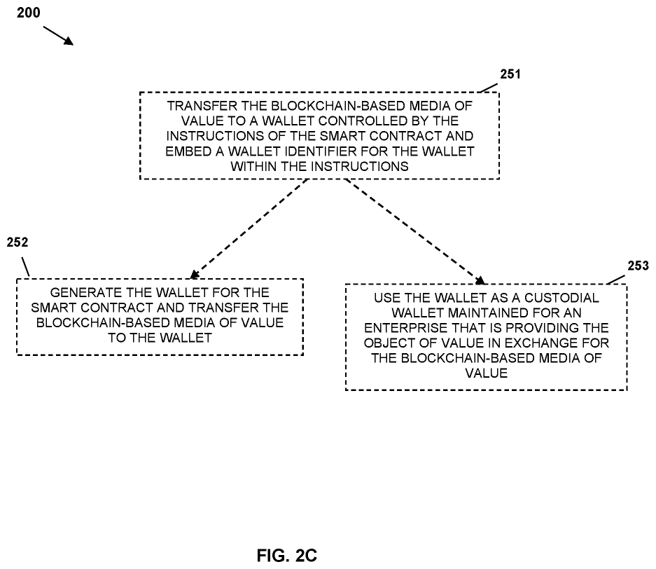

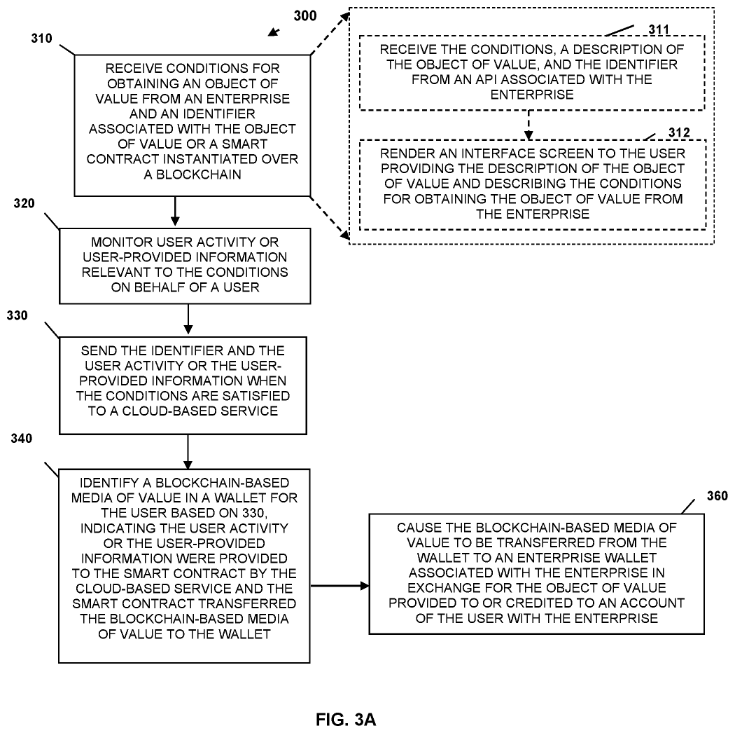

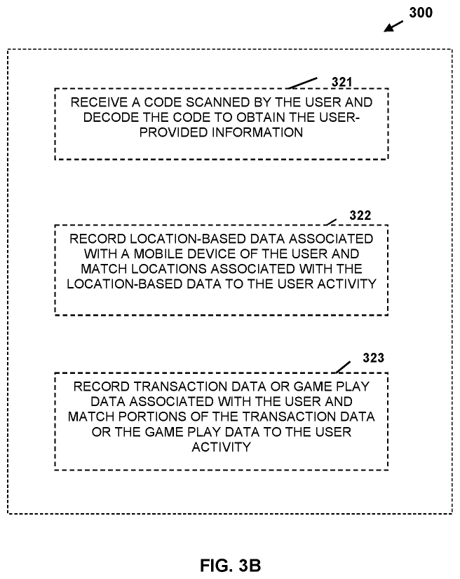

The above-referenced embodiments and other embodiments are now discussed with reference to FIGS. 2A, 2B, 2C, 3A, and 3B. FIGS. 2A, 2B, and 2C are diagrams of a method 200 of managing and integrating NFTs, according to an example embodiment. The software module(s) that implements the method 200 is referred to as a “blockchain-based media of value integrator.” The blockchain-based media of value integrator is implemented as executable instructions programmed and residing within memory and/or a non-transitory computer-readable (processor-readable) storage medium and executed by one or more processors of a device or set of devices. The processor(s) of the device(s) that executes the blockchain-based media of value integrator are specifically configured and programmed to process the blockchain-based media of value integrator. The blockchain-based media of value integrator may have access to one or more network connections during its processing. The network connections can be wired, wireless, or a combination of wired and wireless.

In an embodiment, the blockchain-based media of value integrator executes on server 110. In an embodiment, the server 110 is one of several servers logically presenting and cooperating as a single server representing a cloud 110 or a cloud processing environment 110.

In an embodiment, the blockchain-based media of value integrator is one, all, or some combination of 113, 114, 115, and/or 133. In an embodiment, blockchain-based media of value integrator presents another, and in some ways, an enhanced processing perspective from that which was discussed above with system 1006.

At 210 (shown in FIG. 2A), the blockchain-based media of value integrator receives conditions for obtaining an object of value. The blockchain-based media of value integrator also receives a description of the object of value.

In an embodiment, at 211 (shown in FIG. 2A), the blockchain-based media of value integrator receives the conditions through an interface 123 from an enterprise. The object of value is associated with an award being offered by the enterprise to their customers. The award can be an in-person experience, merchandise, cash back, loyalty reward points, loyalty status bump, a coupon, a promotion, a game artifact for a game, a ticket to an event, an exclusively offered item, digital art, etc.

At 220 (shown in FIG. 2A), the blockchain-based media of value integrator creates a blockchain-based media of value for the object of value on a blockchain. In an embodiment, the blockchain-based media of value is an NFT that can be redeemed for the object of value.

In an embodiment of 211 and 220, at 221 (shown in FIG. 2A), the blockchain-based media of value integrator notifies the enterprise through the interface 123 that the blockchain-based media of value has been created on the blockchain for the award. The enterprise may then wait to receive an identifier for referencing a smart contract that enforces the conditions to transfer the blockchain-based media of value.

At 230 (shown in FIG. 2A), the blockchain-based media of value integrator generates instructions for the conditions in a smart contract. Instructions of the smart contract when executed over the blockchain enforce the conditions received at 210.

At 240 (shown in FIG. 2A), the blockchain-based media of value integrator establishing an identifier for referencing the smart contract over the blockchain. The identifier may be an address for the smart contract over the blockchain devices 130 of the blockchain.

At 250 (shown in FIG. 2A), the blockchain-based media of value integrator provides control over the blockchain-based media of value to the instructions of the smart contract. That is, the instructions of the smart contract dictate whether or not the blockchain-based media of value is transferred to a different wallet and out of the control of the smart contract.

In an embodiment, at 251 (shown in FIG. 2C), the blockchain-based media of value integrator transfers the blockchain-based media of value to a wallet controlled by the instructions of the smart contract. The blockchain-based media of value integrator embeds a wallet identifier for the wallet within the instructions of the smart contract.

In an embodiment of 251 and at 252 (shown in FIG. 2C), the blockchain-based media of value integrator generates the wallet for the smart contract and transfers the blockchain-based media of value to the wallet. At this point, only the smart contract instructions can transfer the blockchain-based media of value out of the wallet to a different wallet.

In an embodiment of 251 and at 252 (shown in FIG. 2C), the blockchain-based media of value integrator uses the wallet as a custodial wallet 115 for an enterprise. The enterprise is providing the object of value in exchange for the blockchain-based media of value.

At 260 (shown in FIG. 2A), the blockchain-based media of value integrator instantiates the smart contract 133 over the blockchain. The smart contract is accessible for interaction via the identifier established at 240.

At 270 (shown in FIG. 2A), the blockchain-based media of value integrator provides the identifier for interacting with the instructions of the smart contract 133 on the blockchain. The identifier allows other services to reach and interact with the smart contract 133 over the blockchain.

In an embodiment, at 271 (shown in FIG. 2A), the blockchain-based media of value integrator provides the identifier to an enterprise through an interface 123. The enterprise is providing the object of value in exchange for the blockchain-based media of value.

In an embodiment of 271 and at 272 (shown in FIG. 2A), the blockchain-based media of value integrator assesses a fee to an account associated with the enterprise. This is done for creating the blockchain-based media of value and instantiating the smart contract 133 on the blockchain. It is noted that other fees may be assessed as well, which were discussed above with the discussion of system 100B.

In an embodiment, at 280 (shown in FIG. 2B), the blockchain-based media of value integrator receives the identifier and data relevant to the conditions from a mobile application 143 operated by a user or a customer of an enterprise. The blockchain-based media of value integrator provides the data and a wallet identifier associated with a custodial wallet 115 of the user to the smart contract 133 using the identifier.

In an embodiment of 280 and at 281 (shown in FIG. 2B), the blockchain-based media of value integrator receives the blockchain-based media of value in the custodial wallet 115 from the smart contract 133. This is an indication that the data received from the mobile application 143 satisfied or met the conditions.

In an embodiment of 281 and at 282 (shown in FIG. 2B), the blockchain-based media of value integrator credits a user wallet associated with the mobile application 143 of the user with the blockchain-based media of value held in the custodial wallet 115. The blockchain-based media of value integrator may use a ledger to show that the blockchain-based media in the custodial wallet 115 for the user was credited to the user wallet of the mobile application 143.

In an embodiment of 282 and at 283 (shown in FIG. 2B), the blockchain-based media of value integrator receives an authorization from the user to transfer the blockchain-based media of value to a second custodial wallet 115 associated with an enterprise. The enterprise is providing the object of value in exchange for the blockchain-based media of value. The blockchain-based media of value integrator transfers the blockchain-based media of value from the custodial wallet 115 to the second custodial wallet 115 based on the authorization. The blockchain-based media of value integrator credits an enterprise wallet with the blockchain-based media of value and debits the user wallet associated with the mobile application 143 and the custodial wallet 115 for the user to remove the blockchain-based media of value.

FIGS. 3A and 3B are diagrams of another method 300 of managing and integrating NFTs, according to an example embodiment. The software module(s) that implements the method 300 is referred to as an “mobile enterprise blockchain-based media of value application.” The mobile enterprise blockchain-based media of value application is implemented as executable instructions programmed and residing within memory and/or a non-transitory computer-readable (processor-readable) storage medium and executed by one or more processors of a device or set of devices. The processor(s) of the device that executes the mobile enterprise blockchain-based media of value application are specifically configured and programmed to process the mobile enterprise blockchain-based media of value application. The mobile enterprise blockchain-based media of value application may have access to one or more network connections during its processing. The network connections can be wired, wireless, or a combination of wired and wireless.

In an embodiment, the device that executes mobile enterprise blockchain-based media of value application is device 140. In an embodiment device 140 is a phone, a laptop, a tablet, and IoT device, or a wearable processing device.

In an embodiment, the mobile enterprise blockchain-based media of value application is all of, or some combination of, 143 and/or 144. The mobile enterprise blockchain-based media of value application presents another and, in some ways, an enhanced processing perspective from that which was described above for enterprise application 143. The mobile enterprise blockchain-based media of value application interacts with service 113, APIs 125, and method 200.

At 310 (shown in FIG. 3A), the mobile enterprise blockchain-based media of value application receives conditions for obtaining an object of value from an enterprise and an identifier associated with the object of value or a smart contract 133 instantiated over a blockchain. That is, the mobile enterprise blockchain-based media of value application does not need to know the address or reference to the smart contract 133 when service 113 maintains a linkage between the smart contract identifier/address and an identifier for the object of value.

In an embodiment, at 311 (shown in FIG. 3A), the mobile enterprise blockchain-based media of value application receives the conditions, a description of the object of value, and the identifier from an API 125 associated with an enterprise. The enterprise is managing a game, a promotion, or some other CRM-related activity through the conditions that need to be satisfied by a customer/user to obtain a blockchain-based media of value from the smart contract 133 and exchanged for the object of value.

In an embodiment of 311 and at 312 (shown in FIG. 3A), the mobile enterprise blockchain-based media of value application renders an interface screen to the user providing the description of the object of value and describing the conditions for obtaining the object of value from the enterprise. The mobile enterprise blockchain-based media of value application provides a front-end user-facing interface for interacting with the user and a back-end interface for interacting with the APIs 125 and service 113.

At 320 (shown in FIG. 3A), the mobile enterprise blockchain-based media of value application monitors user activity or user-provided information relevant to the conditions on behalf of the user. That is, when the user does something makes a purchase, visits a particular location, etc. that are related to the conditions, the mobile enterprise blockchain-based media of value application records this and compares against the conditions.

In an embodiment, at 321 (shown in FIG. 3B), the mobile enterprise blockchain-based media of value application receives a code (for example, a QR code) scanned by the user. The mobile enterprise blockchain-based media of value application decodes the code to obtain the user-provided information.

In an embodiment, at 322 (shown in FIG. 3B), the mobile enterprise blockchain-based media of value application records location-based data associated with a mobile device 140 of the user and matches the locations associated with the location-based data to the user activity. For example, the conditions may be store locations that the user needs to visit, such that mobile enterprise blockchain-based media of value application captures this by matching a given store's location to a location in the device's location-based data.

In an embodiment, at 323 (shown in FIG. 3B), the mobile enterprise blockchain-based media of value application record transaction data or game play data associated with the user. The mobile enterprise blockchain-based media of value application matches portions of the transaction data or the game play data to the user activity. So, the conditions can be purchase based or game play based.

At 330 (shown in FIG. 3A), the mobile enterprise blockchain-based media of value application sends the identifier and the user activity or the user-provided information to a cloud-based service 113 when the conditions are satisfied. The cloud-based service 113 performs the operations discussed above with system 1006 and method 200.

At 340 (shown in FIG. 3A), the mobile enterprise blockchain-based media of value application identifies a blockchain-based media of value in a wallet for the user based on the sending of the identifier and the user activity or the user-provided information to the cloud-based service 113. This indicates the user activity, or the user-provided information were provided to the smart contract 133 by the cloud-based service 113 and the smart contract 133 transferred the blockchain-based media of value to the wallet of the user/customer of the enterprise.

At 350 (shown in FIG. 3A), the mobile enterprise blockchain-based media of value application causes the blockchain-based media of value to be transferred from the wallet to an enterprise wallet associated with the enterprise. In exchange therefore, the enterprise provides the object of value or credits the object of value to an account of the user/customer with the enterprise.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner. The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving conditions for obtaining an object of value;
creating a blockchain-based media of value for the object of value on a blockchain;
generating instructions for the conditions in a smart contract;
establishing an identifier for referencing the smart contract over the blockchain;
providing control over the blockchain-based media of value to the instructions of the smart contract;
instantiating the smart contract over the blockchain; and
providing the identifier for interacting with the instructions of the smart contract on the blockchain.

2. The method of claim 1 further comprising:
receiving the identifier and data relevant to the conditions from a mobile application operated by a user; and
providing the data and a wallet identifier associated with a custodial wallet of the user to the smart contract using the identifier.

3. The method of claim 2 further comprising:
receiving the blockchain-based media of value in the custodial wallet from the smart contract.

4. The method of claim 3 further comprising:
crediting a user wallet associated with the mobile application with the blockchain-based media of value held in the custodial wallet.

5. The method of claim 4 further comprising:
receiving an authorization from the user to transfer the blockchain-based media of value to a second custodial wallet associated with an enterprise that is providing the object of value in exchange for the blockchain-based media of value;
transferring the blockchain-based media of value from the custodial wallet to the second custodial wallet based on the authorization; and
crediting an enterprise wallet with the blockchain-based media of value and debiting the user wallet associated with the mobile application and the custodial wallet of the blockchain-based media of value.

6. The method of claim 1, wherein receiving further includes receiving the conditions through an interface from an enterprise, wherein the object of value is associated with an award being offered by the enterprise to customers.

7. The method of claim 6, wherein creating further includes notifying the enterprise through the interface that the blockchain-based media of value has been created on the blockchain for the award.

8. The method of claim 1, wherein providing control further transferring the blockchain-based media of value to a wallet controlled by the instructions of the smart contract and embedding a wallet identifier for the wallet within the instructions.

9. The method of claim 8, wherein transferring further includes generating the wallet for the smart contract and transferring the blockchain-based media of value to the wallet.

10. The method of claim 8, wherein transferring further includes using the wallet as a custodial wallet maintained for an enterprise that is providing the object of value in exchange for the blockchain-based media of value.

11. The method of claim 1, wherein providing the identifier further includes providing the identifier to an enterprise through an interface, wherein the enterprise providing the object of value in exchange for the blockchain-based media of value.

12. The method of claim 1, wherein providing the identifier further includes assessing a fee to an account associated with the enterprise for creating the blockchain-based media of value and instantiating the smart contract on the blockchain.

13. A method, comprising:
receiving conditions for obtaining an object of value from an enterprise and an identifier for the object of value or a smart contract instantiated over a blockchain;
monitoring user activity or user-provided information relevant to the conditions on behalf of a user;
sending the identifier and the user activity or the user-provided information when the conditions are satisfied to a cloud-based service;
identifying a blockchain-based media of value in a wallet of the user based on the sending, indicating the user activity or the user-provided information where provided to the smart contract on the blockchain by the cloud-based service and the smart contract transferred the blockchain-based media of value to the wallet; and
causing the blockchain-based media of value to be transferred from the wallet to an enterprise wallet associated with the enterprise in exchange for the object of value provided to or credited to an account of the user with the enterprise.

14. The method of claim 13, wherein receiving further includes receiving the conditions, a description of the object of value, and the identifier from an Application Programming Interface (API) associated with the enterprise.

15. The method of claim 14 further comprising, rendering an interface screen to the user providing the description of the object of value and describing the conditions for obtaining the object of value from the enterprise.

16. The method of claim 13, wherein monitoring further includes receiving a code scanned by the user and decoding the code to obtain the user-provided information.

17. The method of claim 13, wherein monitoring further includes recording location-based data associated with a mobile device of the user and matching locations associated with the location-based data to the user activity.

18. The method of claim 13, wherein monitoring further includes recording transaction data or game play data associated with the user and matching portions of the transaction data or game play data to the user activity.

19. A system, comprising:
a server comprising at least one processor and a non-transitory computer-readable storage medium;
the non-transitory computer-readable storage medium comprises executable instructions;
the executable instructions when executed by the at least one processor from the non-transitory computer-readable storage medium cause the at least one processor to perform operations comprising:
receiving conditions for obtaining an object of value from an enterprise through an interface;
generating a blockchain-based media of value for the object of value over a blockchain;
generating an identifier for accessing a smart contract on the blockchain;
generating instructions for the smart contract based on the conditions;
embedding control over transferring the blockchain-based media of value within the instructions of the smart contract;
instantiating the smart contract on the blockchain; and
notifying the enterprise through the interface that the blockchain-based media of value was created and the smart contract was instantiated on the blockchain.

20. The system of claim 19, wherein the blockchain-based media of value is a non-fungible token (NFT) and the blockchain is an Ethereum blockchain.
